(19) United States
(12) Patent Application Publication
(10) Pub. No.: US 2006/0283387 A1
(43) Pub. Date: Dec. 21, 2006

(54) Painter and method of painting

(75) Inventor: Kouichi Takeda, Yamagata (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Kouichi TAKEDA, Nishimurayama-gun (JP)

(21) Appl. No.: 11/154,516

(22) Filed: Jun. 17, 2005

(51) Int. Cl. B05D 7/00; B05D 1/02; B05B 5/025

(52) U.S. Cl. 118/620; 427/421.1

(57) ABSTRACT

There is provided a painter including (a) a static eraser which removes static electricity from air, (b) a tank containing a paint therein, (c) a spray gun which mixes the paint with air supplied from the static eraser, and sprays the paint to an object, and (d) a device located between the static eraser and the spray gun which device retains air therein. Positively or negatively charged ionized air supplied from the static eraser is retained in the device. In the device, the positively charged ionized air is mixed with the negatively charged ionized air, and resultingly, electrically neutral air is supplied from the device to the spray gun.

### BACKGROUND OF THE INVENTION

1. Field of the Invention

The invention relates to a painter and a method of painting, and more particularly to a painter and a method of painting in both of which static electricity is removed from air, and then, the air is mixed with a paint.

2. Description of the Related Art

For instance, when a paint is applied to a body of an automobile, there is sometimes generated non-uniformity in painting. It is known that such non-uniformity is caused by static electricity.

In general, static electricity is generated by friction between different materials. Hence, static electricity is already generated when a body of an automobile is puttied for pretreatment of painting.

In addition, static electricity is further accumulated in various polishing steps. For instance, since a bumper, one of parts of an automobile, is composed of insulating material such as plastic, when a polishing step is applied to a bumper, the bumper is completely electrically charged after the polishing step has been finished.

In particular, when a metallic-color paint is applied to an automobile, non-uniformity in painting is likely to be generated by static electricity. A metallic-color paint contains a lot of quite small metal particles. Since those metal particles are electrically conductive, if static electricity is accumulated on a body of an automobile, the metal particles are attracted to the static electricity. As a result, there is generated non-uniformity in painting on a body of an automobile.

In general, an object such as an automobile is painted by spraying a mixture of a paint and air thereto through a spray gun. Such air sprayed through a spray gun is generally electrically charged. Specifically, when air flows through an air tube, air is electrically charged before sprayed through a spray gun, because of friction between air and an inner surface of the air tube. Since electrically charged air attracts ambient dusts, such dusts are resultingly adhered to an object to be painted with a paint.

Thus, in order to prevent non-uniformity in painting caused by static electricity, it is necessary to completely remove static electricity from an object to be painted, such as an automobile, or remove static electricity from air to be sprayed together with a paint through a spray gun.

It is generally easier to remove static electricity from air than to remove static electricity from an object to be painted. Hence, many apparatuses and methods have been suggested to remove static electricity when an object is painted. As an example of such apparatuses, the apparatus for removing static electricity, suggested in Japanese Utility Model Publication No. 3009802 published on Apr. 11, 1995, is illustrated in FIGS. 1 and 2.

As illustrated in FIG. 1, the apparatus is comprised of a filter 1 which removed moisture and oil from compressed air, a paint tank 2 filled with a paint, a gun 3 spraying a mixture of a paint and air, a high pressure hose 4 making fluid communication between the filter 1 and the gun 3, and a shield cable 5.

The filter 1, the high pressure hose 4 and the shield cable 5 are arranged in a box 10.

A leakage transformer 6 as illustrated in FIG. 2 is also arranged in the box 10. The leakage transformer 6 can raise a voltage supplied from a generally used AC power source up to about 7000 volts. The leakage transformer 6 includes a 10M Ω-resistor 7, three capacitors 8, and three discharge needles 9 each electrically connected to each of the capacitors 8, at its high voltage terminal. The discharge needles 9 are radially arranged in an outlet of the gun 3, and are arranged in facing relation to the high pressure hose 4 (not illustrated in FIG. 2).

The shield cable 5 includes a high-voltage terminal line and an earth terminal line, and extends from the gun 3 to the leakage transformer 6 arranged in the box 10. The earth terminal line is electrically connected to a fixed terminal 12 through an earth line 11.

When a high voltage is applied to the discharge needles 9, electrons are ejected from the discharge needles 9, resulting in that air is accompanied with electron avalanche, and hence, there is generated corona discharge. As a result, positive ions and negative ions are alternately produced around the discharge needles 9. These positive and negative ions are sprayed through the gun 3 together with a paint by compressed air supplied through the high pressure hose 4.

Static electricity accumulated on an object to be painted is neutralized with the ionized air. At the same time, dusts having been adhered to the object are blown out.

However, the above-mentioned apparatus is accompanied with a problem that since air sprayed through the gun 3 has been already electrically charged when sprayed, the air attracts ambient dusts before reaching an object to be painted, resulting in that those dusts are adhered to the object.

Japanese Utility Model Publication No. 3013762 has suggested an apparatus for removing static electricity, comprising a high voltage source, a tube in which ions are generated, a discharge needle arranged in the tube, opposing electrodes arranged in the tube, a high pressure tube for introducing compressed air into the tube, a gun through which a paint and air are sprayed, and a pressure control valve arranged in the gun. The high voltage source has two output terminals one of which is electrically connected to the discharge needle, and the other is electrically connected to the opposing electrodes.

Japanese Unexamined Patent Publication No. 7-296985 has suggested an apparatus for vaporizing electrically conductive liquid. The apparatus is comprised of an electrically insulating container containing electrically conductive liquid therein, and a high voltage source. The electrically conductive liquid is vaporized, and at the same time, ionized while the high voltage source applies a high voltage to the electrically conductive liquid.

Japanese Unexamined Patent Publication No. 11-109069 has suggested an electronic device comprising a main case formed with a transparent window through which a person can see what is contained in the main case. The main case and the window are both composed of the same transparent resin. The main case is coated with a colored underlying coating and a transparent coating on the colored underlying coating, and the window is coated with the transparent coating.

Japanese Unexamined Patent Publication No. 7-18412 has suggested a method of treating a surface of a work, including the steps of spraying ionized gas to a surface of a work to thereby remove static electricity from the surface, radiating ultra-violet ray to the surface of the work to thereby clean the surface, and forming a thin film on the surface.

However, the above-mentioned problem remains unsolved even by the above-mentioned apparatuses and methods suggested in the Publications.

### SUMMARY OF THE INVENTION

In view of the above-mentioned problem in the conventional apparatus for removing static electricity, it is an object of the present invention to provide an apparatus and a method of removing static electricity from air when an object is to be painted with a mixture of a paint and air.

In one aspect of the present invention, there is provided a painter including (a) a static eraser which removes static electricity from air, (b) a tank containing a paint therein, (c) a spray gun which mixes the paint with air supplied from the static eraser, and sprays the paint to an object, and (d) a device located between the static eraser and the spray gun which device retains air therein, wherein positively or negatively charged ionized air supplied from the static eraser is retained in the device, positively charged ionized air is mixed with negatively charged ionized air in the device, and electrically neutral air is supplied from the device to the spray gun.

The inventors of the present invention had found out that it is more effective to spray electrically neutral air than to spray positively or negatively charged ionized air, as done in the conventional apparatus illustrated in FIGS. 2 and 3, in order to prevent non-uniformity in painting. If air is electrically neutral, the air will not attract dusts thereto when sprayed to an object to be painted.

The present invention is based on this discovery.

In accordance with the above-mentioned apparatus, while the positively or negatively charged ionized air supplied from the static eraser is being accumulated in the device such as a tank, the positively charged air is combined with the negatively charged air, resulting in that air becomes electrically neutral. The thus made electrically neutral air is sprayed through the spray gun together with a paint, ensuring non-uniformity in painting an object.

It is preferable that the device has a volume at least ten times greater than a volume of air discharged from the static eraser in a unit period of time.

If the device had a too small volume, it would not be possible to facilitate positively and negatively charged ionized air supplied from the static eraser, to combine with each other. Hence, the inventors had conducted the experiment to know how much volume the device had to have. In accordance with the experiment, it was found out that if the device had a volume ten times greater than a volume of air to be discharged from the static eraser in a unit period of time, it was possible to facilitate the positively and negatively charged ionized air to combine with each other. Accordingly, it is preferable for the device to have a volume defined as NV wherein N is an integer equal to or greater than 10, and V indicates a volume of air to be discharged from the static eraser in a unit period of time.

For instance, the device may be comprised of a tank for retaining air therein. As an alternative, the device may be comprised of a hose such as a high pressure tube.

There is further provided a painter including (a) a device which supplies a voltage indicated by a user, (b) an ion generator to which the voltage is applied for generating positively and negatively charged ionized air, (c) a spray gun which mixes a paint with the ionized air, and sprays the paint to an object, and (d) a high pressure hose through which the ionized air is fed to the spray gun from the ion generator.

For instance, the ion generator is comprised of a chamber, a positive-ion emitter to which a positive voltage is applied from the device to emit positively charge ionized air, a negative-ion emitter to which a negative voltage is applied from the device to emit negatively charged ionized air, and an electrically grounded plate located between the positive-ion and negative-ion emitters, and having an area smaller than a cross-sectional area of the chamber, wherein the high pressure hose connects the chamber to the spray gun.

The ion generator may include a chamber, in which case, the painter may further include an air dryer through which external air is introduced to the chamber.

The ion generator may include a chamber, in which case, the painter may further include an oil-mist filter through which external air is introduced to the chamber.

The painter may further include an ion sensor for counting the positively and negatively charged ions, and transmitting signals indicative of the positively and negatively charged ions, to the device, and wherein the device adjusts the positive and negative voltages in accordance with the received signals.

In another aspect of the present invention, there is provided a method of painting an object, including the steps of (a) removing static electricity from air, (b) retaining positively and negatively charged ionized air resulted from the step (a), in a retainer, to thereby mix the positively and negatively charged ionized air to each other to render air electrically neutral, and (c) mixing the electrically neutral air with a paint, and applying the paint onto an object.

In accordance with the above-mentioned method, while the positively or negatively charged ionized air is being accumulated in the retainer, the positively charged air is combined with the negatively charged air, resulting in that air becomes electrically neutral. The thus made electrically neutral air is sprayed through the spray gun together with a paint, ensuring non-uniformity in painting an object.

It is preferable that the positively and negatively charged ionized air is retained in a tank in the step (b). As an alternative, the positively and negatively charged ionized air may be retained in a tube in the step (b).

There is further provided a method of painting an object, including the steps of (a) generating positively and negatively charged ionized air, (b) feeding said positively and negatively charged ionized air to a spray gun through a high pressure hose, in which said positively and negatively charged ionized air are mixed to each other to render the air electrically neutral, and (c) mixing said electrically neutral air with a paint, and applying said paint onto an object.

The method may further include (d) counting numbers of said positively and negatively charged ionized air, and (e) generating said positively and negatively charged ionized air in accordance with said numbers.

The advantages obtained by the aforementioned present invention will be described hereinbelow.

In accordance with the present invention, while the positively or negatively charged ionized air supplied from the static eraser is being accumulated in the device such as a tank or a hose, the positively charged air is combined with the negatively charged air, resulting in that the air becomes electrically neutral. The thus made electrically neutral air is sprayed through the spray gun together with a paint, ensuring non-uniformity in painting an object.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 illustrates a conventional apparatus for removing static electricity.

FIG. 2 illustrates the static eraser which is a part of the apparatus illustrated in FIG. 1.

FIG. 3 illustrates a painter in accordance with the first embodiment of the present invention.

FIG. 4 illustrates a painter in accordance with the second embodiment of the present invention.

FIG. 5 illustrates a painter in accordance with the third embodiment of the present invention.

### DESCRIPTION OF THE PREFERRED EMBODIMENTS

Preferred embodiments in accordance with the present invention will be explained hereinbelow with reference to drawings.

### First Embodiment

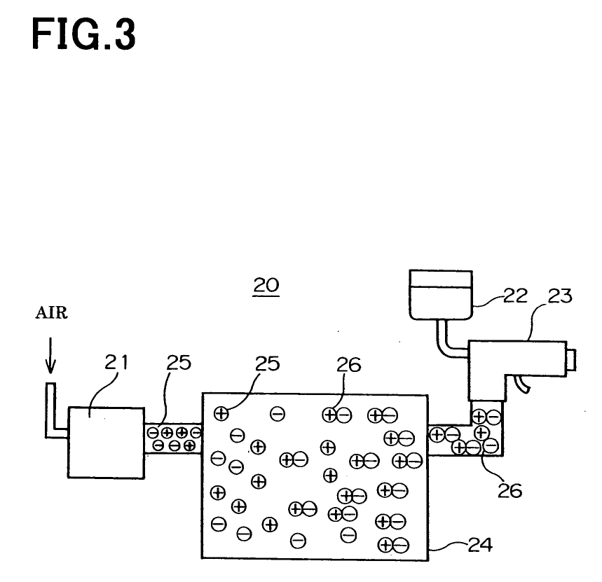

FIG. 3 illustrates a painter 20 in accordance with the first embodiment of the present invention.

A painter 20 in accordance with the first embodiment is comprised of a static eraser 21 which removed static electricity from air, a paint tank 22 filled with a paint, a spray gun 23 in which air supplied from the static eraser 21 is mixed with a paint supplied from the paint tank 22, and which sprays the mixture of the air and paint, and a tank 24 located between the static eraser 21 and the spray gun 23 for retaining air therein.

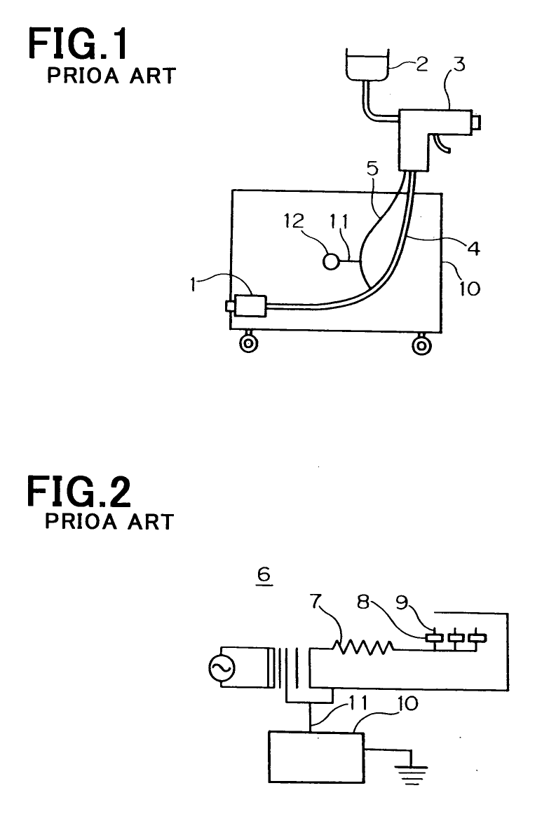

For instance, the static eraser 21 in the embodiment may be comprised of the static eraser illustrated in FIGS. 1 and 2. However, the static eraser 21 is not to be limited to that. Any apparatus which can remove static electricity may be used as the static eraser 21 in the embodiment.

The tank 24 has a volume ten times greater than a volume of air discharged from the static eraser 21 in a unit period of time.

The painter 20 in accordance with the first embodiment operates as follows.

Positively and negatively charged ionized air 25 supplied from the static eraser 21 is once retained in the tank 24. The positively and negatively charged ionized air are combined with each other in the tank 24, resulting in that the air 25 is turned into electrically neutral ions 26.

The thus made electrically neutral ions 26 are fed to the spray gun 23, and sprayed to an object through the spray gun 23 together with a paint supplied from the paint tank 22.

As mentioned above, in accordance with the painter 20, the positively or negatively charged ionized air 25 supplied from the static eraser 21 can be turned into the electrically neutral ions 26 by once retaining the charged ionized air 25 in the tank 24. By spraying the electrically neutral air 26 through the spray gun 23 together with a paint, it is possible to paint an object without non-uniformity in painting.

Though the painter 20 in accordance with the embodiment is provided with the tank 24 as a device for retaining air therein, a device for retaining air therein is not to be limited to the tank 24. Any means can be used as such a device, if the means had such a volume as to be able to combine positively and negatively charged ionized air supplied from the static eraser 21, to each other to thereby render the air electrically neutral. For instance, a high pressure hose may be used in place of the tank 24, as a device for retaining air therein, as explained in the second embodiment described hereinbelow.

### Second Embodiment

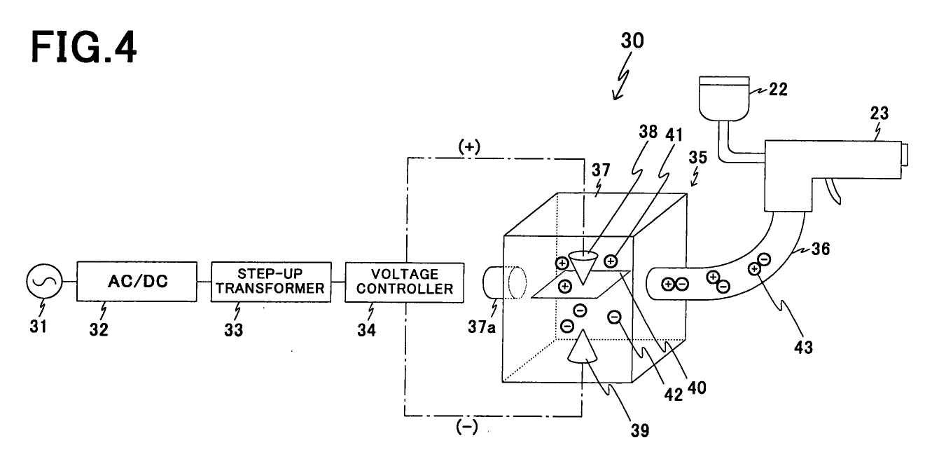

FIG. 4 illustrates a painter 30 in accordance with the second embodiment of the present invention.

The painter 30 is comprised of an AC voltage source 31, a converter 32 for converting an AC voltage into a DC voltage, a step-up transformer 33 for raising a voltage supplied from the converter 32, a voltage controller 34 for turning a voltage supplied from the step-up transformer 33 into a desired voltage in accordance with an input signal transmitted from a user, a ion generator 35, a paint tank 22 filled with a paint, a spray gun 23 in which air supplied from the ion generator 35 is mixed with a paint supplied from the paint tank 22, and which sprays the mixture of the air and paint onto an object (not illustrated), and a high pressure horse 36 through which ions generated by the ion generator 35 is supplied to the spray gun 23.

The AC voltage source 31 supplies 100 V in AC, for instance.

The converter 32 converts AC 100 V into DC 24 V. On receipt of the DC 24 V from the converter 32, the step-up transformer 33 transforms the DC 24 V into an absolute voltage of 7 kV, for instance. That is, the step-up transformer 33 turns the DC 24 V into ±7 kV.

The voltage controller 34 is provided with a rotary dial (not illustrated). When a user rotates the rotary dial to indicate a desired voltage, the voltage controller 34 turns the ±7 kV into the desired voltage indicated by a user. For instance, the voltage controller 34 turns the ±7 kV into a range of ±4 kV to ±10 kV.

The ion generator 35 is comprised of a chamber 37, a plate 40 arranged horizontally in the chamber 37, a positive-ion emitter 38, and a negative-ion emitter 39.

The plate 40 is smaller in an area than a cross-sectional area of the chamber 37. Accordingly, the plate 40 is spaced at an outer edge thereof away from an inner surface of the chamber 37.

In addition, the plate 40 is kept at zero volt. In other words, the plate 40 is electrically grounded.

The chamber 37 is formed with an air inlet 37a through which air is supplied into the chamber 37.

The positive-ion emitter 38 is in the form of a cone, directing at a summit thereof towards the plate 40. The positive-ion emitter 38 is electrically connected to the voltage controller 34, and receives a positive voltage from the voltage controller 34.

The negative-ion emitter 39 is in the form of a cone, directing at a summit thereof towards the plate 40. The negative-ion emitter 39 is electrically connected to the voltage controller 34, and receives a negative voltage from the voltage controller 34.

The painter 30 in accordance with the second embodiment operates as follows.

The converter 32 converts an AC voltage supplied from the AC voltage source 31, into a DC voltage. The step-up transformer 33 transforms the DC voltage into a voltage having a higher absolute value. The voltage controller 34 turns the voltage supplied from the step-up transformer 33 into a voltage which a user indicated by rotating the rotary dial.

The voltage controller 34 supplies a positive voltage to the positive-ion emitter 38. On receipt of the positive voltage from the voltage controller 34, the positive-ion emitter 38 generates positively charged ionized air 41 in accordance with the received positive voltage.

The voltage controller 34 simultaneously supplies a negative voltage to the negative-ion emitter 39. On receipt of the negative voltage from the voltage controller 34, the negative-ion emitter 39 generates negatively charged ionized air 42 in accordance with the received negative voltage.

Since the plate 40 has a smaller area than a cross-sectional area of the chamber 37, a space in which the positively charged ionized air 41 exist and a space in which the negatively charged ionized air 42 are in gas-communication with each other. Thus, the positively charged ionized air 41 and the negatively charged ionized air 42 are mixed with each other in the chamber 37 to some degree.

The thus generated positively and negatively charged ionized air 41 and 42 are fed into the high pressure hose 36. While being fed to the spray gun 23, the positively and negatively charged ionized air 41 and 42 are combined with each other in the high pressure hose 36, resulting in that the positively and negatively charged ionized air 41 and 42 are turned into electrically neutral ions 43.

The electrically neutral ions 43 are fed to the spray gun 23, and sprayed to an object through the spray gun 23 together with a paint supplied from the paint tank 22.

As mentioned above, in accordance with the painter 30, the positively or negatively charged ionized air 41 and 42 supplied from the ion generator 35 can be turned into the electrically neutral ions 43 by feeding through the high pressure hose 36. By spraying the electrically neutral ions 43 through the spray gun 23 together with a paint, it is possible to paint an object without non-uniformity in painting.

Though the painter 30 in accordance with the second embodiment is designed to include the AC voltage source 31 and the AC-DC voltage converter 32, the painter 30 may be designed to include a DC voltage source in place of the AC voltage source 31 and the AC-DC voltage converter 32.

### Third Embodiment

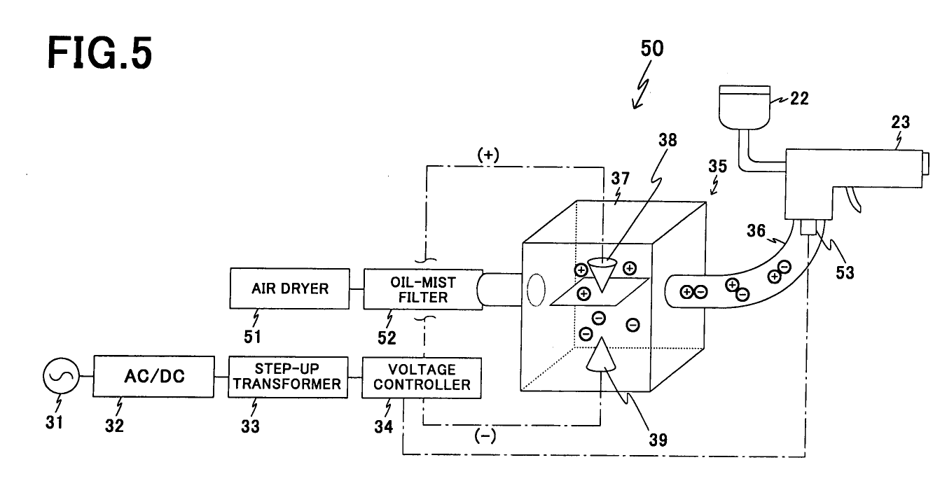

FIG. 5 illustrates a painter 50 in accordance with the third embodiment of the present invention.

The painter 50 additionally includes an air dryer 51, an oil-mist filter 52, and an ion sensor 53 in comparison with the painter 30 illustrated in FIG. 4.

The air dryer 51 and the oil-mist filter 52 are connected to the air inlet 37a of the chamber 37. Hence, air is introduced into the chamber 37 through the air dryer 51 and the oil-mist filter 52. While passing through the air dryer 51, moisture is removed from the air. While passing through the oil-mist filter 52, oil-mist is removed from the air. Thus, dry and non-oily air is introduced into the chamber 37.

The ion sensor 53 is arranged in the high pressure hose 36 at a boundary between the high pressure hose 36 and the spray gun 23. The ion sensor counts a number of the positively charged ions 41 and further a number of the negatively charged ions 42, and transmits signals indicative of the thus calculated numbers of the ions 41 and 42, to the voltage controller 34.

On receipt of the signals from the ion sensor 53, the voltage controller 34 adjusts the positive voltage to be applied to the positive-ion emitter 38, in accordance with the received signal indicative of the number of the positively charged ions 41, and further adjusts the negative voltage to be applied to the negative-ion emitter 39, in accordance with the received signal indicative of the number of the negatively charged ions 42. Specifically, if the received signals show that the calculated number of the positively charged ions 41 is greater than a designed number, the voltage controller 34 lowers the positive voltage to be applied to the positive-ion emitter 38, and vice versa. Similarly, if the received signals show that the calculated number of the negatively charged ions 42 is greater than a designed number, the voltage controller 34 lowers the negative voltage to be applied to the negative-ion emitter 39, and vice versa.

Thus, the painter 50 including the ion sensor 53 can automatically keep the numbers of the positively and negatively charged ions 41 and 42 equal to the designed or desired numbers.

Though the painter 50 is designed to include the air dryer 51, the oil-mist filter 52, and the ion sensor 53, the painter 50 may be designed to include any one or any two of them.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed is:

1. A painter comprising:
(a) a static eraser which removes static electricity from air;
(b) a tank containing a paint therein;
(c) a spray gun which mixes said paint with air supplied from said static eraser, and sprays said paint to an object; and
(d) a device located between said static eraser and said spray gun, retaining air therein,
wherein positively or negatively charged ionized air supplied from said static eraser is retained in said device, positively charged ionized air is mixed with negatively charged ionized air in said device, and electrically neutral air is supplied from said device to said spray gun.

2. The painter as set forth in claim 1, wherein said device has a volume at least ten times greater than a volume of air discharged from said static eraser in a unit period of time.

3. The painter as set forth in claim 1, wherein said device is comprised of a tank for retaining air therein.

4. The painter as set forth in claim 1, wherein said device is comprised of a tube.

5. The painter as set forth in claim 2, wherein said device is comprised of a tank for retaining air therein.

6. The painter as set forth in claim 2, wherein said device is comprised of a tube.

7. A painter comprising:
(a) a device which supplies a voltage indicated by a user;
(b) an ion generator to which said voltage is applied for generating positively and negatively charged ionized air;
(c) a spray gun which mixes a paint with said ionized air, and sprays said paint to an object; and
(d) a high pressure hose through which said ionized air is fed to said spray gun from said ion generator.

8. The painter as set forth in claim 7, wherein said ion generator is comprised of:
a chamber;
a positive-ion emitter to which a positive voltage is applied from said device to emit positively charge ionized air;
a negative-ion emitter to which a negative voltage is applied from said device to emit negatively charged ionized air; and
an electrically grounded plate located between said positive-ion and negative-ion emitters, and having an area smaller than a cross-sectional area of said chamber,
wherein said high pressure hose connects said chamber to said spray gun.

9. The painter as set forth in claim 7, wherein said ion generator includes a chamber, and further comprising an air dryer through which external air is introduced to said chamber.

10. The painter as set forth in claim 7, wherein said ion generator includes a chamber, and further comprising an oil-mist filter through which external air is introduced to said chamber.

11. The painter as set forth in claim 8, further comprising an ion sensor for counting said positively and negatively charged ions, and transmitting signals indicative of said positively and negatively charged ions, to said device, and wherein said device adjusts said positive and negative voltages in accordance with the received signals.

12. A method of painting an object, comprising the steps of:
(a) removing static electricity from air;
(b) retaining positively and negatively charged ionized air resulted from said step (a), in a retainer, to thereby mix said positively and negatively charged ionized air to each other to render air electrically neutral; and
(c) mixing said electrically neutral air with a paint, and applying said paint onto an object.

13. The method as set forth in claim 12, wherein said positively and negatively charged ionized air is retained in a tank in said step (b).

14. The method as set forth in claim 12, wherein said positively and negatively charged ionized air is retained in a tube in said step (b).

15. A method of painting an object, comprising the steps of:
(a) generating positively and negatively charged ionized air;
(b) feeding said positively and negatively charged ionized air to a spray gun through a high pressure hose, in which said positively and negatively charged ionized air are mixed to each other to render the air electrically neutral; and
(c) mixing said electrically neutral air with a paint, and applying said paint onto an object.

16. The method as set forth in claim 15, further comprising:
(d) counting numbers of said positively and negatively charged ionized air; and
(e) generating said positively and negatively charged ionized air in accordance with said numbers.
